(19) United States
(12) Patent Application Publication
(10) Pub. No.: US 2020/0326555 A1
(43) Pub. Date: Oct. 15, 2020

(54) GRADUATED FILTER ASSEMBLY

(71) Applicant: Carl Zeiss Microscopy GmbH, Jena, (DE)

(72) Inventors: Dr. Matthias WALD, Jena (DE); Dr. Dieter HUHSE, Berlin (DE)

(73) Assignee: Carl Zeiss Microscopy GmbH, Jena, (DE)

(21) Appl. No.: 16/305,568

(22) PCT Filed: May 23, 2017
(86) PCT No.: PCT/EP2017/062331

§ 371 Date: Nov. 29, 2018

(30) Foreign Application Priority Data
Jun. 1, 2016 (DE) 10 2016 209 524.2

(51) Int. Cl. G02B 27/12; G02B 21/00

(52) U.S. Cl. CPC G02B 27/126; G02B 21/0076; G02B 21/0052; G02B 21/0032

(57) ABSTRACT

A graduated filter arrangement, an optical arrangement having a graduated filter arrangement, and uses of a graduated filter arrangement, where the filter arrangement has a graduated filter that is moveable in relation to a beam path and is provided in an intended filter plane, and a mirror in a mirror plane. The mirror plane and the intended filter plane are aligned fixedly in relation to one another and relative to one another in such a way that a beam of light rays that is incident at an angle of incidence along the beam path is reflected, at least in part, between the graduated filter and the mirror in such a way that there at least is a two-fold deflection of the incident light ray by the graduated filter arrangement and the reflected light ray is reflected as a beam of reflected light rays at a deflection angle. The optical effect of a present angle error between the intended filter plane and an actual filter plane provided by the current relative position of the chief plane of the graduated filter is reduced as a consequence of the at least two-fold deflection, and the deflection angle remains constant.

### RELATED APPLICATIONS

The present application is a U.S. National Stage application of International PCT Application No. PCT/EP2017/062331 filed on May 23, 2017 which claims priority benefit of German Application No. DE 10 2016 209 524.2 filed on Jun. 1, 2016, the contents of each are incorporated by reference in their entirety.

### FIELD OF THE INVENTION

The invention relates to a graduated filter arrangement according to the preamble of claim 1. The invention further relates to an optical arrangement having a graduated filter arrangement, a microscope having a graduated filter arrangement and the use of the graduated filter arrangement.

### BACKGROUND OF THE INVENTION

A graduated filter is an optical filter, in particular with dichroic layers. The graduated filter has regions with different spectral filter properties (“spectrally selective regions”) that are arranged parallel to one of its surfaces, which are preferably plane. The optical transmittance of the filter is, firstly, wavelength-dependent and it differs for at least one wavelength in different regions of the filter.

By way of example, graduated filters are known from DE 10 2014 008 098 A1, which describes an optical filter apparatus comprising a filter, in particular with dichroic layers, said filter having regions with different spectral filter properties that are arranged parallel to one of its surfaces.

DE 10 2012 205 722 A1 describes an imaging color splitter module with an imaging optical unit having a first lens and a second lens for imaging an object field into a first and a second image plane, and a color splitter. The color splitter divides a common beam path extending from the object field to the color splitter into a first beam path, which extends to the first image plane, and into a second beam path, which extends to the second image plane, wherein the common beam path and the first beam path each extend in an off-axis manner through the first lens and the second beam path extends in an off-axis manner through the second lens.

A beam path that is typical for the prior art when using a graduated filter 2 in a microscope 16, such as, e.g., a laser scanning microscope, is illustrated schematically in FIG. 1. The graduated filter 2 is applied to one side face of a carrier 3 that is transparent to certain wavelengths or wavelength ranges to be transmitted.

An incident light ray 6, for example of excitation or illumination radiation, is partly cast back as a reflected light ray 7 at the graduated filter 2, which is formed by a dielectric coating. A further component of the incident light ray 6 passes through the graduated filter 2 and the carrier 3 and continues as a transmitted light ray 8 after being refracted twice. The incident light ray 6 and the reflected light ray 7 include a deflection angle α.

A disadvantage of such a graduated filter 2 and carrier 3 is that the relative ray position of the reflected light ray 7 already is modified very strongly by a minor tilt of the graduated filter 2 about the Y-axis Y. By way of example, such tilts may occur if the relative spatial position of the graduated filter 2 is changed, for example by displacement.

In the case of an occurring tilt with a tilt angle β (only specified for elucidation purposes), which is never completely avoidable in the case of a mechanical displacement, the reflected light ray 7 is deflected by a double angle β. Accordingly, depending on the application, high demands in respect of the accuracy of the mechanical guide have to be met, and so the production of the mechanical guide is correspondingly expensive and complicated.

### SUMMARY OF THE INVENTION

The invention is based on the object of proposing a graduated filter arrangement, in which occurring tilts of the graduated filter lead to a small change in the relative beam position. Furthermore, the invention is based on the object of proposing possible uses of the graduated filter arrangement and optical arrangements comprising the graduated filter arrangement.

In respect of the graduated filter arrangement, this object is achieved by the subject matter of claim 1. In respect of the optical arrangement, this object is achieved by the subject matter of claim 10, and in respect of the uses of the graduated filter arrangement, this object is achieved by the subjects of claim 11.

Advantageous configurations are found in the dependent claims.

The graduated filter arrangement comprises a graduated filter that is moveable in relation to a beam path and provided in an intended filter plane, and a mirror in a mirror plane.

According to the invention, the mirror plane and the intended filter plane are aligned fixedly in relation to one another and relative to one another in such a way that a beam of light rays that is incident at an angle of incidence along the beam path is reflected, at least in part, between the graduated filter and the mirror in such a way that there at least is a two-fold deflection of the incident light ray by the graduated filter arrangement. The reflected light ray is reflected as a beam of light rays from the graduated filter arrangement at an angle of reflection, wherein a present angle error between the intended filter plane and an actual filter plane provided by the current relative position of the chief plane of the graduated filter is reduced, or even compensated as a consequence of the at least two-fold deflection, and the angle of reflection remains constant relative to the angle of incidence.

It was recognized that an at least two-fold reflection of the incident light ray, which reflections together result in a deflection of said incident light ray, allows the disadvantageous changes in the relative beam position to be reduced if both reflection faces are fixedly connected to one another and thereby always tilted together.

The intended filter plane denotes a plane in which the graduated filter extends with its greatest extent in the ideal case while the actual filter plane denotes a plane with a current relative position, in which the graduated filter currently extends with its greatest extent. An angle deviation between the intended filter plane and the actual filter plane is denoted as a tilt angle β.

The graduated filter arrangement is movable in relation to the beam path of the incident light ray. Its position along the beam path and/or its relative angle position in relation to the beam path are changeable.

In a possible embodiment of the graduated filter arrangement, the graduated filter is embodied on a side face of a pentaprism. The mirror is formed by one of the other side faces of the pentaprism. A pentaprism has the property that the reflected light ray is always deflected by exactly 90° in relation to the incident light ray, regardless of how the pentaprism is twisted.

Suitable prisms with different numbers of side faces to that of a pentaprism may be used in a further embodiment of the graduated filter arrangement.

Further possible embodiments of the graduated filter arrangement according to the invention are configured in such a way that the beam path between graduated filter and mirror does not extend through a body. In this way, the graduated filter and mirror can be fixedly arranged relative to one another and, for example, have a common base.

A graduated filter arrangement according to the invention has to be chosen in such a way that, in the case of a tilt of the graduated filter in at least one direction, the deflection angle of the reflected light ray changes less than the change in angle of the graduated filter itself. This is advantageously achieved by a pentaprism.

Configurations of the graduated filter arrangement, in which the incident light ray is incident on the graduated filter with a small angle of incidence of, e.g., 10°, are advantageous. The angle of incidence on the graduated filter may vary, depending on the demands on the filter properties. By way of example, 10° was found to be a good compromise between filter properties, which are best in the case of an angle of incidence of 0°, and a separation of incident and reflected light ray. The angle-stabilizing properties of a pentaprism remain untouched by the angles of incidence.

In order to compensate a deflection of the transmitted light ray, which may occur on account of the prism effect, an optical compensation element is disposed downstream of the graduated filter on or after its side face facing away from the mirror in one possible embodiment of the graduated filter arrangement. By way of example, the compensation element can be embodied as a prism.

The mirror can be embodied as a coating, having a reflective effect, of a surface and by the interface of one of the side faces of a prism. In a further configuration possibility of the graduated filter arrangement, the mirror is embodied as a retroreflector, for example as a corner mirror or a so-called cat's-eye.

In further configurations, the graduated filter arrangement can be embodied in such a way that the incident beam of light rays is reflected from the graduated filter to the mirror and is reflected or reflectable back to the graduated filter from said mirror.

The graduated filter, which is embodied, for example, as a main color splitter of a microscope, is struck twice by the illumination light in these embodiments before it is deflected into a beam path of the microscope, for example. As a result of this double use, an error in the relative beam position compensates itself. The angle error of a first reflection is compensated by way of a second reflection at a component that is afflicted by relative position tolerances.

The illumination light advantageously serves as excitation light. Here, the emission of fluorescence radiation can be excited by means of the excitation light and/or components of the excitation light impinging on a specimen are reflected as reflection light. Fluorescence radiation and/or reflection light are able to be captured as detection radiation.

Possibly remaining residual errors in the form of angle errors perpendicular to the deflection of the graduated filter and small lateral offsets of the reflected light ray are compensated by the double use of the graduated filter as a reflection face.

At least one optical lens can be arranged between the graduated filter on the mirror in order to shape, e.g., bundle or focus, the light rays reflected by the graduated filter and/or the light rays reflected back to the graduated filter again by the mirror.

The graduated filter arrangement can be embodied to be displaceable along one axis. To this end, the graduated filter arrangement may comprise a carriage that is displaceable along the axis.

The graduated filter arrangement can be part of an optical arrangement. Advantageously, the graduated filter arrangement is part of a microscope, for example a laser scanning microscope.

Advantageously, the graduated filter arrangement can be used to reduce, or even compensate, an angle error between the intended filter plane and the actual filter plane provided by the chief plane of the graduated filter.

Such a compensation option offers great potential for increasing the efficiency of imaging systems. An example is given by the input coupling of a reflected light ray into an optical fiber with, e.g., a core diameter of 100 In the case of a typical focal length of an input coupling lens of 5 mm, the focal spot downstream of the input coupling lens is already displaced by approximately 10 μm in the case of a change in angle of the reflected light ray of 0.1°, i.e., in the case of a tilt of the graduated filter of 0.05°, which already results in noticeable input coupling losses.

### BRIEF DESCRIPTION OF THE FIGURES

The invention is explained in more detail below on the basis of exemplary embodiments and figures. In the figures:

FIG. 1 is a schematic illustration of a beam profile on a graduated filter (prior art);

FIG. 2 is a schematic illustration of a first exemplary embodiment of a graduated filter arrangement according to the invention in cross section;

FIG. 3 is a schematic illustration of a second exemplary embodiment of a graduated filter arrangement according to the invention in cross section;

FIG. 4 is a schematic illustration of a third exemplary embodiment of a graduated filter arrangement according to the invention in cross section;

FIG. 5 is a schematic illustration of a fourth exemplary embodiment of a graduated filter arrangement according to the invention in cross section;

FIG. 6 is a schematic illustration of a fifth exemplary embodiment of a graduated filter arrangement according to the invention in a perspective view; and

FIG. 7 is a schematic illustration of a sixth exemplary embodiment of a graduated filter arrangement according to the invention.

### DETAILED DESCRIPTION OF THE EMBODIMENTS

In the schematically illustrated drawings of the exemplary embodiments, the same reference signs denote the same technical elements.

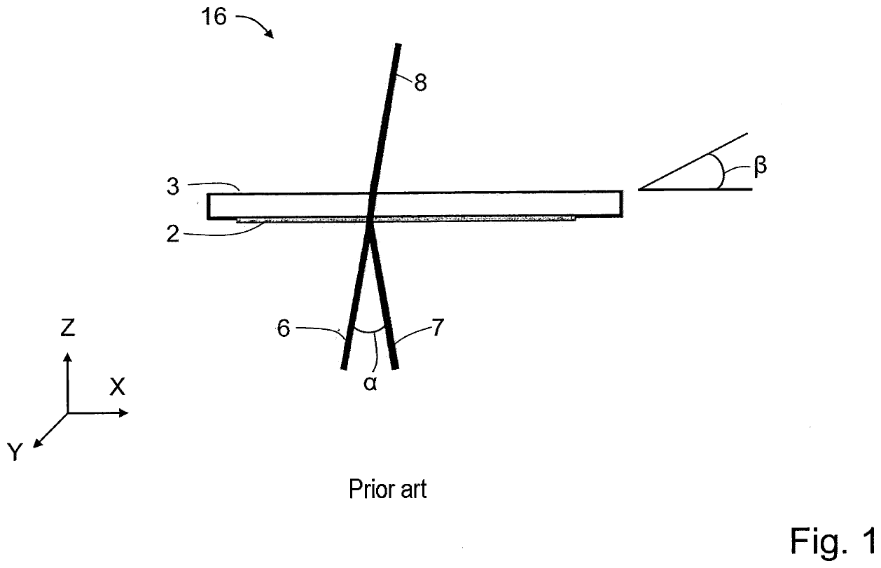

The beam profile on a graduated filter 2 illustrated in FIG. 1 substantially lies in an XZ-plane XZ of a Cartesian coordinate system with an X-axis X, a Y-axis Y and a Z-axis Z.

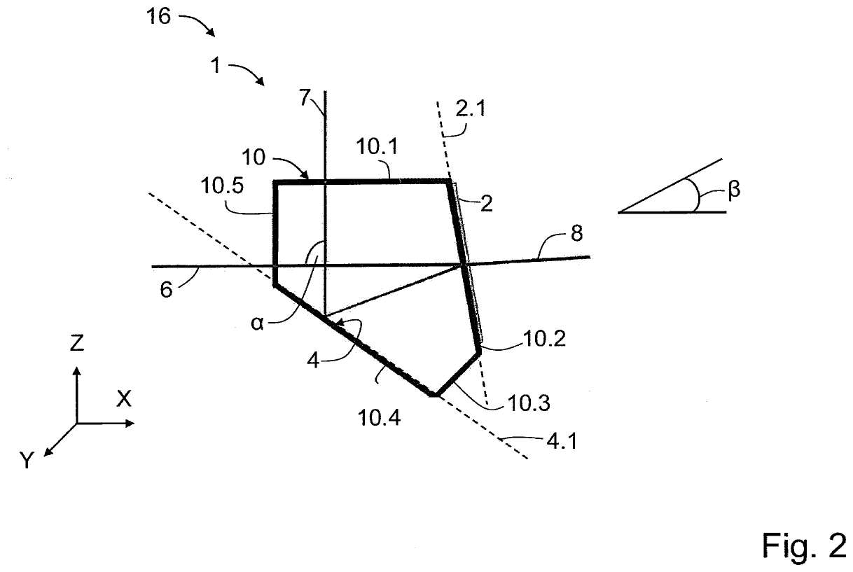

In a first exemplary embodiment of a graduated filter arrangement 1, which is illustrated in FIG. 2, a pentaprism 10 is present, said pentaprism being shown in a lateral illustration and having first to fifth side faces 10.1, 10.2, 10.3, 10.4 and 10.5. The graduated filter 2 is applied to the second side face 10.2. The fourth side face 10.4 is mirrored and acts as a mirror 4. The plane of the second side face 10.2 coincides with a filter plane 2.1, which corresponds to an actual filter plane of the graduated filter 2 and in which the graduated filter 2 extends. The fourth side face 10.4 coincides with a mirror plane 4.1. The intended filter plane and the actual filter plane 2.1 coincide in the non-tilted state of the graduated filter 2.

In the exemplary embodiments, the graduated filter arrangement 1 is illustrated schematically as part of an optical arrangement 16, in particular a microscope 16.

An incident light ray 6 of an illumination light enters into the pentaprism 10 through the fifth side face 10.5 and a portion thereof is reflected at the filter plane 2.1 by the effect of the graduated filter 2.

A non-reflected portion of the light ray 6 passes through the graduated filter 2 and propagates as transmitted light ray 8.

The reflected portion of the light ray 6 is reflected again at the mirror plane 4.1 and emerges as a reflected light ray 7 from the first side face 10.1.

The incident light ray 6 and the reflected light ray 7 include the deflection angle α.

By way of example, should the graduated filter arrangement 1 be tilted about the Y-axis Y through the tilt angle β, shown here in a schematic fashion and with exaggerated dimensions for reasons of improved clarity, the deflection angle α remains constant due to the effect of the two-fold reflection between graduated filter 2 and mirror 4 in the case of a simultaneously fixed relative position between graduated filter 2 and mirror 4.

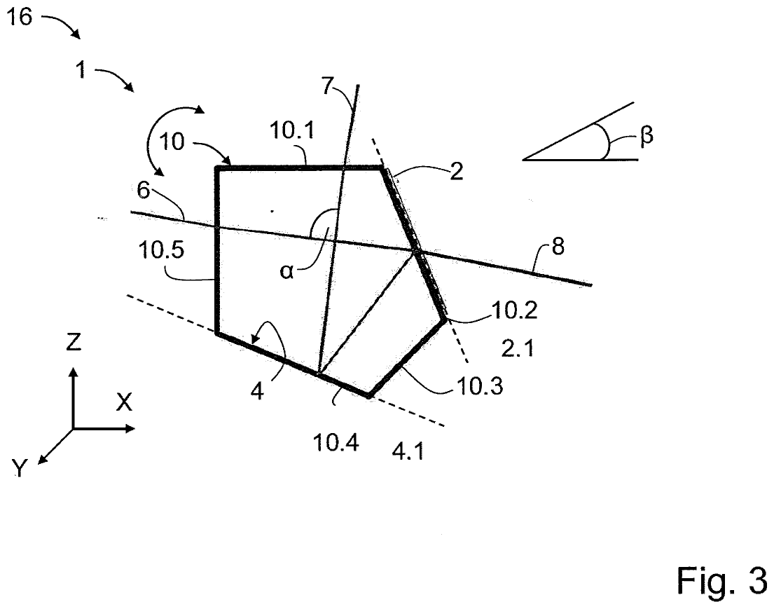

In a second exemplary embodiment of the graduated filter arrangement 1, in FIG. 3, a pentaprism 10 is present with a shape that has changed in relation to the first exemplary embodiment. In the case of a tilt movement about the Y-axis Y and with the tilt angle β, the deflection angle α remains constant.

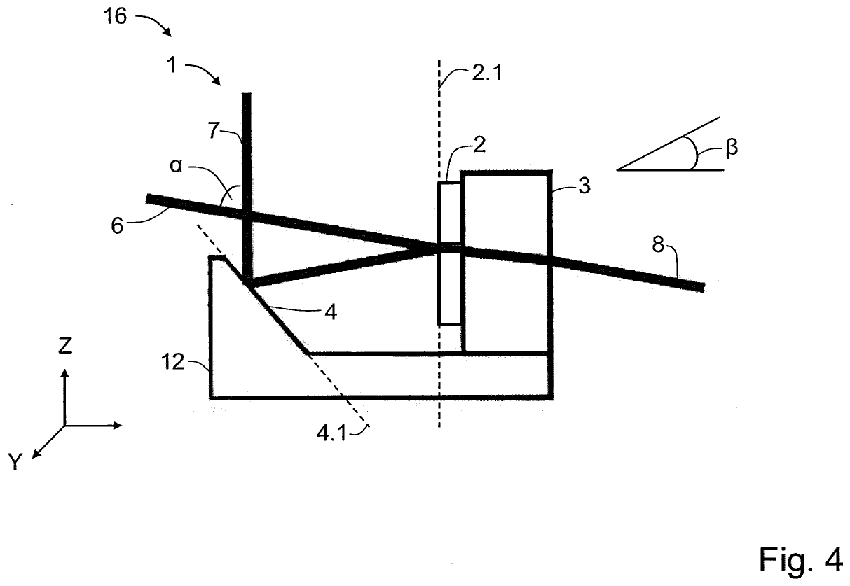

In a third exemplary embodiment, an L-shaped or U-shaped graduated filter arrangement 1 is illustrated instead of a pentaprism 10 (FIG. 4). The graduated filter 2 is formed on a surface of the carrier 3. The carrier 3 has a rigid connection to the mirror 4 by means of a mirror base 12. The mirror 4 is formed as a reflective layer on an inclined plane surface of the mirror base 12. As a consequence of the rigid connection between graduated filter 2 with carrier 3 and mirror 4, these are aligned fixedly in relation to one another and relative to one another in such a way that a beam of light rays 6 that is incident at an angle of incidence along the beam path is reflected, at least in part, between the graduated filter 2 and the mirror 4 in such a way that there is a two-fold deflection of the incident light ray 6 by the graduated filter arrangement 1. The reflected light ray 7 is guided is a free ray between the graduated filter 2 and the mirror 4.

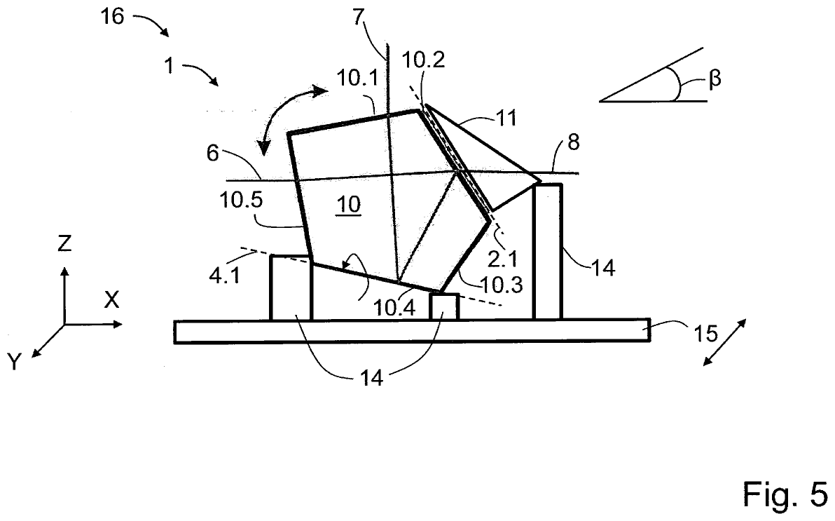

FIG. 5 shows a fourth exemplary embodiment of the graduated filter arrangement 1. It is embodied as a pentaprism 10 and assembled on a carriage 15 by means of fastening elements 14, said carriage rendering the graduated filter arrangement 1 displaceable along the X-axis X.

By way of example, the graduated filter 2 is displaced into an image plane of a microscope 16, for example, in order to strike other positions on the graduated filter 2. On account of the optical properties of the pentaprism 10, the reflected light ray 7 is always deflected through a deflection angle α of 90° in relation to the incident light ray 6, independently of the tilt angle β.

Thus, if there is an unwanted tilt in the direction of the Y-axis Y as a result of displacing the carriage 15 with the graduated filter arrangement 1, this does not lead to a change in the deflection angle α and in the reflected light ray 7. Although tilt movements about the X-axis X, illustrated horizontally in FIG. 5, still lead to changes in the deflection angle α (see FIGS. 2 to 4), these are less than tilt movements about the Z-axis Z on account of the usually relatively long installation length of the carriage 15. The changes in the deflection angle α in the case of a tilt movement about the X-axis X only have exactly the same size as the changes in the relative mechanical position.

In order to compensate a deflection of the transmitted light ray 8, a compensation element 11 in the form of a further prism is also fastened to the carriage 15 in the beam path of the transmitted light ray 8, and so the graduated filter arrangement 1 and the compensation element 11 move together and, where appropriate, are also tilted together. In this way, the transmitted light beam 8 always travels at a constant angle, i.e., in the same direction.

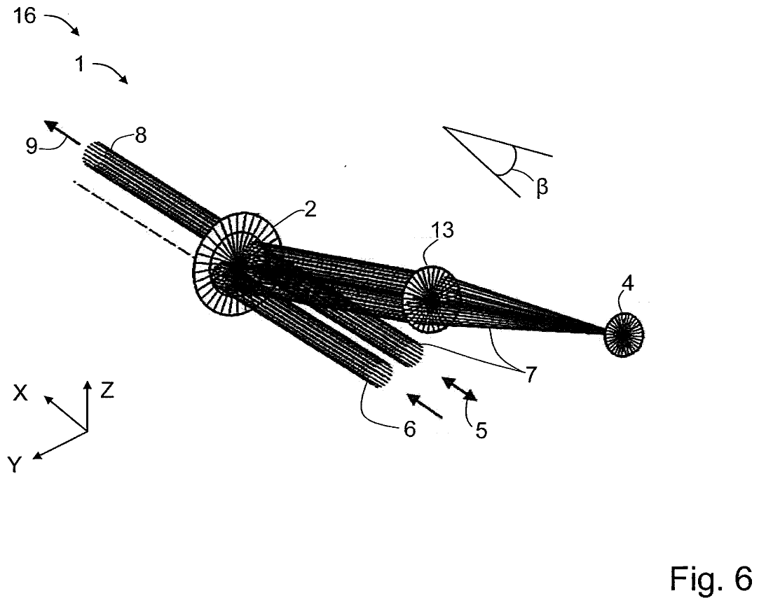

In the fifth exemplary embodiment of the graduated filter arrangement 1, illustrated in FIG. 6 in perspective fashion, a section of a microscope 16 with a graduated filter arrangement 1 is shown schematically.

In a microscope 16, which is typically embodied as a laser scanning microscope (LSM), there is also a graduated filter 2, denoted as a main color splitter, as a central functional element, said graduated filter separating a detection beam path 9 from an excitation beam path 5, both of which are symbolized by arrows. Here, a beam of incident light rays 6 is reflected at the graduated filter 2, deflected by the effect of the mirror 4 and the graduated filter 2 and steered onto a sample (not illustrated) along the excitation beam path 5 as a reflected light ray 7.

From the sample, the fluorescence signal, which is shifted in terms of wavelength, passes through the microscope 16 as detection light, once again reaches the graduated filter 2 and it is now transmitted there on account of the longer wavelength (transmitted light ray 8).

In the further course of the detection beam path 9, the light of the transmitted light ray 8 reaches a pinhole or an Airy scan detector (both not shown), for example. Relative position tolerances of the graduated filter 2 have an effect on the reflected light ray 7. As a consequence, a slightly different point in the sample is struck after a change in the tilt angle β than prior to the change. Detection light of the impact position is imaged into the pinhole plane with a detection-side offset and it misses the pinhole, causing a loss of signal.

The beam of incident light rays 6 is reflected onto the mirror 4 by the graduated filter 2 and returns back to the graduated filter 2 from said mirror. The light of the light ray 7 that has now been reflected twice by the graduated filter 2 is directed onto the sample along the excitation beam path 5. Detection light received by the sample is incident on the graduated filter 2 and guided along the detection beam path 9 as a transmitted light ray 8 on account of its modified wavelength, to which the graduated filter 2 is transparent.

All angle errors exactly compensate one another in the present configuration of the graduated filter arrangement 1. A graduated filter 2 is imaged onto itself for the purposes of avoiding a lateral offset. For detection purposes, the graduated filter 2 is used in a simple pass, and so no disadvantages arise in relation to the prior art.

The solution using an adjustment mirror in the excitation beam path 5, by means of which a respective deviation of actual and intended filter plane is compensated where necessary and which was previously used in the prior art, is not required if use is made of the graduated filter arrangement 1 according to the invention. This advantageously allows tracking of the adjustment mirror to be dispensed with in the case of a change in relative position of the graduated filter 2. Advantageously, a change mechanism for the graduated filter 2 can have a simpler configuration.

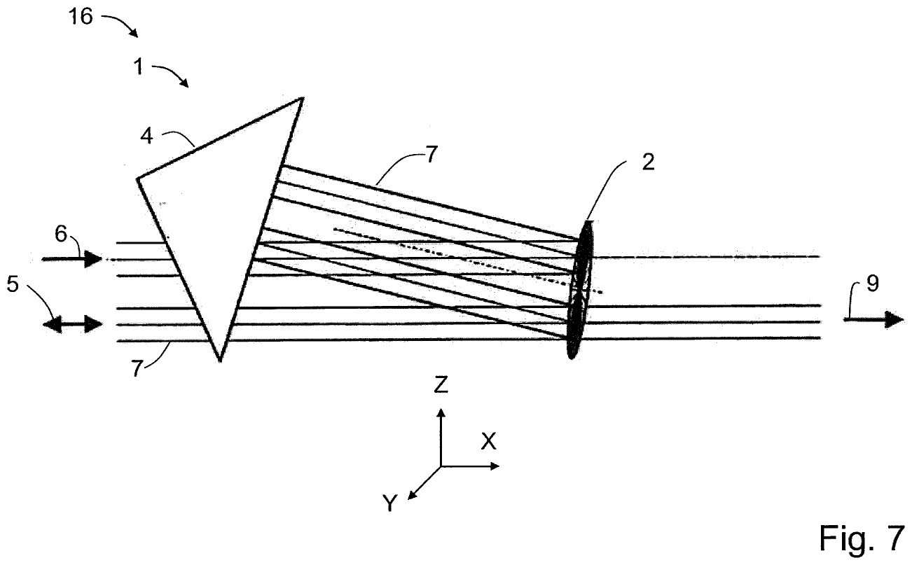

A further configuration option is illustrated in FIG. 7, where there is no imaging of the graduated filter 2 onto itself, in contrast to the exemplary embodiment shown in FIG. 6. Instead, a retroreflector is arranged as a mirror 4 for the purposes of deflecting the incident light ray 6 so that the light ray 7 reflected at the graduated filter 2 can be reflected back without a change in angle. The beam path of the beam of reflected light rays 7 in or on the mirror 4 is not illustrated.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE SIGNS

1 Graduated filter arrangement
2 Graduated filter
2.1 Actual filter plane
3 Carrier
4 Mirror
4.1 Mirror plane
5 Excitation beam path
6 Incident light ray
7 Reflected light ray
8 Transmitted light ray
9 Detection beam path
10 Pentaprism
10.1 First side face
10.2 Second side face
10.3 Third side face
10.4 Fourth side face
10.5 Fifth side face
11 Compensation element
12 Mirror base
13 Optical lens
14 Fastening element
15 Carriage
16 Optical arrangement/microscope
X X-axis
Y Y-axis
Z Z-axis
α Deflection angle
β Tilt angle

1. A graduated filter arrangement comprising a graduated filter that is moveable in relation to a beam path and provided in an intended filter plane, and a mirror in a mirror plane,
said mirror plane and said intended filter plane being aligned fixedly in relation to one another and relative to one another in such a way that a beam of light rays that is incident at an angle of incidence along the beam path is reflected, at least in part, between the graduated filter and the mirror in such a way that there is an at least two-fold deflection of the incident light ray by the graduated filter arrangement, and
said reflected light ray is being reflected as a beam of light rays from the graduated filter arrangement at a deflection angle, wherein a present angle error in the form of a tilt angle between the intended filter plane and an actual filter plane provided by the current relative position of a chief plane of the graduated filter is reduced as a consequence of the at least two-fold deflection, and the deflection angle remains constant.

2. The graduated filter arrangement as claimed in claim 1, wherein said mirror is embodied as a retroreflector.

3. The graduated filter arrangement as claimed in claim 1, wherein said incident beam of light rays is reflected from the graduated filter to the mirror and is reflected or reflectable back to the graduated filter from said mirror.

4. The graduated filter arrangement as claimed in claim 1, further comprising an optical lens arranged between the graduated filter and the mirror.

5. The graduated filter arrangement as claimed in claim 1, wherein said graduated filter is embodied on a side face of a pentaprism and the mirror is formed by one of the other side faces of the pentaprism.

6. The graduated filter arrangement as claimed in claim 5, further comprising an optical compensation element is disposed downstream of the graduated filter on its side face facing away from the mirror.

7. The graduated filter arrangement as claimed in claim 5, wherein said compensation element is embodied as a prism.

8. The graduated filter arrangement as claimed in claim 1, wherein said filter arrangement is embodied to be displaceable along an axis.

9. The graduated filter arrangement as claimed in claim 8, further comprising a carriage that is displaceable along said axis.

10. An optical arrangement comprising a graduated filter arrangement as claimed in claim 1.

11. The use of a graduated filter arrangement as claimed in claim 1 for reducing the optical effect of a tilt angle between an intended filter plane and an actual filter plane provided by a chief plane of a graduated filter.
